(19) United States
(12) Patent Application Publication
(10) Pub. No.: US 2024/0127359 A1
(43) Pub. Date: Apr. 18, 2024

(54) SYSTEM AND METHODS FOR STREAMLINING HEALTH INSURANCE CLAIMS ADJUDICATION IN MUSCULOSKELETAL DIAGNOSTICS AND INTERVENTIONS

(71) Applicant: Intelligent Health Analytics Inc., New York, NY (US)

(72) Inventors: Riley Williams, III, New York, NY (US); Benedict Nwachukwu, New York, NY (US); Prem N. Ramkumar, New York, NY (US)

(73) Assignee: Intelligent Health Analytics Inc., New York, NY (US)

(21) Appl. No.: 18/489,742

(22) Filed: Oct. 18, 2023

Related U.S. Application Data
(60) Provisional application No. 63/417,292, filed on Oct. 18, 2022.

(51) Int. Cl. G06Q 40/08

(52) U.S. Cl. CPC G06Q 40/08

(57) ABSTRACT

A system for streamlining health insurance claims adjudication in musculoskeletal diagnostics and interventions, the system causing a server to: process at least one document and image to produce at least one document and image feature; extract the at least one document and image feature to produce an extracted document and image feature; extract, via a classification and interpretation algorithm, the at least one peer review to produce an extracted opinion feature; analyze at least one social determinant of health to produce at least one analyzed social determinant of health; compile the extracted document feature, the extracted image feature, the extracted opinion feature, and the at least one analyzed social determinant of health to produce a compiled patient data; evaluate the compiled patient data; and produce, based upon the evaluation of the compiled patient data, at least one of a claim approval and a claim denial.

### FIELD OF THE INVENTION

The present disclosure is directed to a system and methods for streamlining the process of adjudicating claims by a health insurance payor. More specifically, the present disclosure is directed to a system and methods for streamlining the process of adjudicating claims by a health insurance payor in the field of musculoskeletal diagnostics and interventions.

### INTRODUCTION

Adjudicating claims following musculoskeletal diagnostic tests or interventions presents a considerable challenge due to its intricate and resource-intensive nature for various stakeholders, including patients, healthcare providers, and insurers (hereafter collectively referred to as “payors”). The successful processing of these claims demands meticulous organization, thorough analysis, and the careful consideration of numerous factors. The comprehensive examination of input data is a prerequisite before approval or denial is issued for musculoskeletal diagnostic tests and the associated payment by the payor.

In particular, claims processing entails the remote assessment of patient eligibility for payment and the valuation of diagnostic tests or interventions provided by healthcare professionals. The current claims approval procedure, especially within the domain of musculoskeletal medicine, results in delays in patient care, lacks insights into clinical effectiveness, and places a significant burden on all parties involved. Additionally, the claims processing approval process aspires to make prompt and well-informed decisions. Nevertheless, this process is hampered by its capacity to assimilate essential claims data and apply clinical expertise.

Clinical and socioeconomic patient data, coupled with insurance information submitted by healthcare providers or patients during the claims approval process, are amalgamated and presented to payors for internal analysis and assessment. Throughout this process, a combination of unverified parameters are meticulously evaluated to determine the extent to which a musculoskeletal service, whether it be a diagnostic test or medical intervention, will be funded by the payor. This process exacts a considerable toll on resources and time for all involved parties. The intricate nature of the claims approval process, especially from the perspective of insurers, necessitates the consideration of numerous variables, each assigned various weights, along with the input of a “peer” in specific scenarios. For instance, various payors assign varying degrees of importance to the numerous variables. Nevertheless, payors frequently leave the assignment of importance unspecified, resulting in a lack of uniformity amongst the various payors. Unfortunately, there is no direct involvement of musculoskeletal professionals or experts in the decision-making process for claims approval. In addition to eligibility criteria and consistent documentation, the latest evidence-based medical knowledge is a prerequisite for advising on claims related to musculoskeletal medicine. Nonetheless, the management and storage of an extensive volume of often disorganized data is essential for making these decisions.

Hence, it is highly desirable to introduce systems and methods designed to standardize data, with the aim of expediting and simplifying the recommendations that influence clinical encounters and costs. Moreover, the implementation of systems and methods incorporating artificial intelligence-based analytical processes is crucial, as they offer unique capabilities for the automated and efficient interpretation of data grounded in clinical expertise. This, in turn, accelerates and streamlines the claims approval process. Additionally, it is also desirable to introduce systems and methods capable of aggregating historical and current payor claims to generate swift prior authorization recommendations.

### SUMMARY

This Summary is provided to introduce a selection of concepts in a simplified form that are further described below in the Detailed Description. This Summary is not intended to identify key features or essential features, nor is it intended to limit the scope of the claims included herewith.

Provided may be a system streamlining health insurance claims adjudication in musculoskeletal diagnostics and interventions, the system comprising a server comprising at least one server processor, at least one server database, at least one server memory comprising a set of computer-executable server instructions which, when executed by the at least one server processor, cause the server to: initiate the system upon the receipt of a claim, the claim comprising at least one of: at least one document, at least one image, at least one peer review, and at least one social determinant of health; process the at least one document to produce at least one document feature; extract the at least one feature to produce an extracted document feature; process the at least one image to produce at least one image feature; extract the at least one image feature to produce an extracted image feature; extract, via a classification and interpretation algorithm, the at least one peer review to produce an extracted opinion feature; analyze at least one social determinant of health to produce at least one analyzed social determinant of health; compile the extracted document feature, the extracted image feature, the extracted opinion feature, and the at least one analyzed social determinant of health to produce a compiled patient data; evaluate the compiled patient data; and produce, based upon the evaluation of the compiled patient data, at least one of a claim approval and a claim denial.

In an embodiment, the at least one document is comprised of at least one of healthcare provider notes from an encounter with the patient and at least one doctor's report. In a further embodiment, the at least one image is comprised of at least one of radiographic imaging, histologic pathology, and serology data.

In an alternative embodiment, processing the at least one document is performed by at least one algorithm. In another embodiment, the at least one algorithm is selected from the group consisting of a Convolutional Neural Network, an ANN, a kNN, a Naïve Bayes, a SVM, and a Decision Tree. In an embodiment, processing the at least one image is performed by the at least one algorithm. In yet a further embodiment, analyzing the at least one social determinant of health is performed by the at least one algorithm.

In an embodiment, the set of computer-executable server instructions which, when executed by the at least one server processor, cause the server to: provide a recommendation for a course of clinical action based upon the compiled patient data. In another embodiment, the set of computer-executable server instructions which, when executed by the at least one server processor, cause the server to: provide a recommendation on a likelihood of success of a musculoskeletal intervention.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates a block diagram of a distributed computer system that can implement one or more aspects of the present invention.

FIG. 2 illustrates a block diagram of an electronic device that can implement one or more aspects of the present invention.

FIG. 3 illustrates an embodiment of a block diagram of the system.

FIG. 4 illustrates an embodiment of a method for streamlining health insurance claims adjudication in musculoskeletal diagnostics and interventions.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

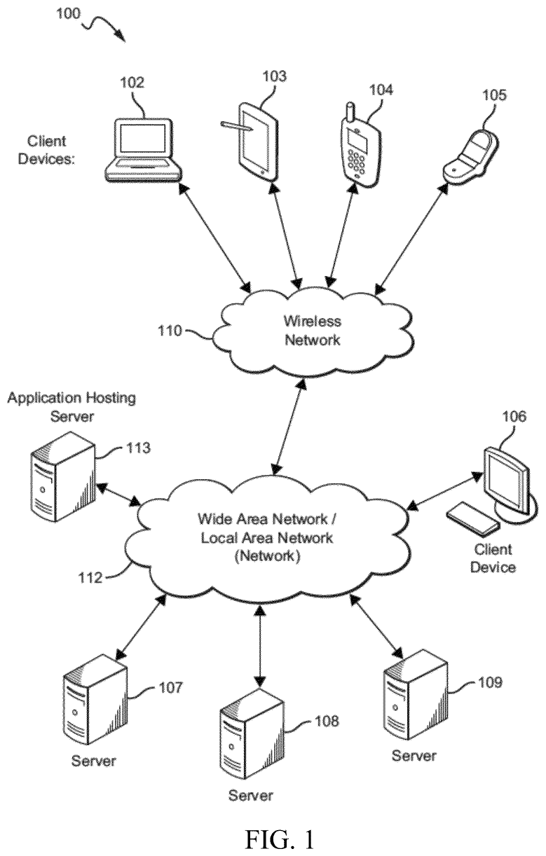

FIG. 1 illustrates components of one embodiment of an environment in which the present disclosure may be practiced. Not all of the components may be required to practice the present disclosure, and variations in the arrangement and type of the components may be made without departing from the spirit or scope of the invention. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. Various of the client devices 102-106 may include, for example, desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

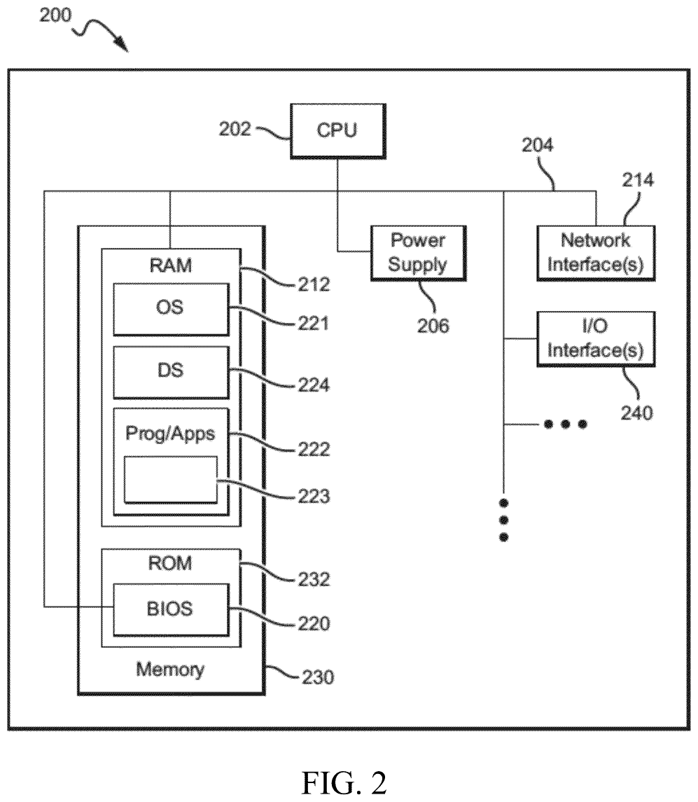

FIG. 2 illustrates a block diagram of an electronic device 200 that can implement one or more aspects of a system and methods for streamlining health insurance claims adjudication in musculoskeletal diagnostics and interventions (the “System”) according to one embodiment of the invention. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the invention. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the System, via a network to another device. Also, an application server may, for example, host a web site that can provide a user interface for administration of example aspects of the System.

Any computing device capable of sending, receiving, and processing data over a wired and/or a wireless network may act as a server, such as in facilitating aspects of implementations of the System. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the System. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the System. Content may include, for example, text, images, audio, video, and the like.

In example aspects of the apparatus, system and method embodying the System, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the System, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the System, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the System, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the System, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the System, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present invention include apparatuses, systems, and methods implementing the System. Embodiments of the present invention may be implemented on one or more of client devices 102-106, which are communicatively coupled to servers including servers 107-109. Moreover, client devices 102-106 may be communicatively (wirelessly or wired) coupled to one another. In particular, software aspects of the System may be implemented in the program 223. The program 223 may be implemented on one or more client devices 102-106, one or more servers 107-109, and 113, or a combination of one or more client devices 102-106, and one or more servers 107-109 and 113.

In an embodiment, the system may receive, process, generate and/or store time series data. The system may include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data.

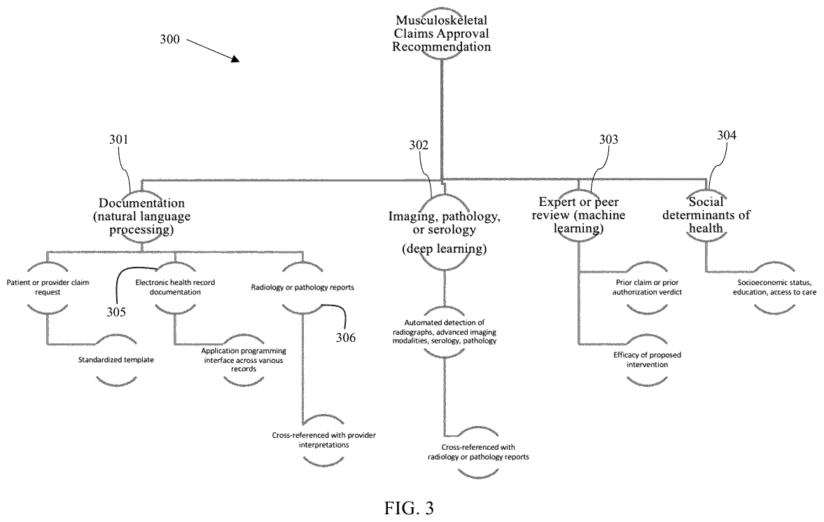

Depicted in FIG. 3 is an illustration of an embodiment of a system for streamlining health insurance claims adjudication in musculoskeletal diagnostics and interventions 300 (hereinafter the “system”).

The system 300 may apply various artificial intelligence-based processes. In an embodiment, said processes may provide unique organizational structures for the system 300. In another embodiment, said structures may be comprised of at least one of Documentation 301, Imaging 302, Expert or Peer Review Opinion 303, and Social Determinants of Health 304.

In an embodiment, the system 300 may be initiated between at least one client device. In another embodiment, the system 300 may be initiated between the at least one client device and another computing device and/or network. In an alternative embodiment, the at least one client device, another computing device, and/or the network have a computing power sufficient to run and/or implement the system 300. It should be noted that persons having ordinary skill in the art will realize that communication between the at least one client device, anther computing device, and/or the network may not be direct between the aforementioned client device, computing device, and network. In yet a further embodiment, the system 300 may instead be indirect, via one or more intermediary devices and/or networks (i.e., the Internet”). The system 300 may interact with the devices partaking in the telemedicine encounter through an API. Further, the system 300 may be adapted to interact with a variety of APIs on multiple platforms.

In one embodiment, the system 300 may be initiated when at least one of a clinical order, an authorization request, or a prior authorization approval request (collectively a “claim”) is submitted by a patient and/or a healthcare provider to a health insurance management company and/or a payer. Moreover, payers may have differing processes for submitting core features of the claim. In an embodiment, the claim may be comprised of basic data, wherein said data may be extracted and/or populated. In such an embodiment, said data may be extracted via a natural language processor (NLP), wherein the NLP may be exploited to fulfill a submission request for maximal interoperability and scalability. In another embodiment, the claim may be submitted to the payer. In another embodiment, the claim may be comprised of Documentation 301.

In an embodiment, Documentation 301 may include at least one document, wherein said document may be an electronic health record 305. Such an electronic health record 305 may include healthcare provider notes from an encounter with the patient, wherein said notes may be processed. In another embodiment, the processing of the Documentation 301 may produce at least one document feature from said record. In a further embodiment, the at least one document feature may include at least one of a present illness history (e.g., the illness': chronicity, patient impact, and/or previously attempted modalities), at least one physical exam finding, an overall provider assessment, and a future patient care plan. Alternatively, an administrator may manually enter this information. In yet a further embodiment, the at least one document feature may be extracted from the electronic health record 305 through an API and/or electronic transmission, thus producing an extracted document feature. Additionally, said extracted document feature may be analyzed using an NLP. The electronic health record 305 may further include at least one doctor's report 306, wherein said doctor's report 306 may be a radiologist report and/or a pathologist report. However, the doctor's report 306 may include any other suitable healthcare specialist and/or doctor's report alternative. Further, the doctor's report 306 may be related to a patient disease and/or illness. In another embodiment, the doctor's report 306 may be related to the claim. The doctor's report 306 may be extracted, wherein said extraction may produce the extracted document feature. In an embodiment, the extraction may be performed by an API and/or electronic transmission. Further, the extracted feature may be analyzed using the NLP.

The claim may further include Imaging 302, wherein said Imaging 302 may be comprised of at least one image. Said at least one image may be comprised of radiographic imaging, histologic pathology, and/or serology data (i.e., laboratory specimens and values). In an embodiment, the at least one image may be processed to produce at least one image feature. Further, the at least one image feature may be extracted, creating the extracted image feature, wherein said extracted image feature may be analyzed. Said analyzation may aid in a decision-making process for claim approval. In another embodiment, the extracted image feature may be preprocessed (i.e., cropped, converted, resized) in terms of pixels, trends, and/or other signal from at least one of an image, a video, and a quantitative value. Said preprocessing may utilize at least one algorithm. In an embodiment, the at least one algorithm may be at least one of a Convolutional Neural Network, an Artificial Neural Networks (ANN), a k-Nearest Neighbor (kNN), a Naïve Bayes, Support Vector Machines (SVM), and a Decision Tree. In another embodiment, the at least one algorithm may aid in clinical diagnosis and/or classification. In a further embodiment, at least one heatmap, at least one class activation map, and/or at least one Shapley Additive Explanation summary aggregate plot may be generated. Alternatively, an administrator may manually enter this information.

The claim may further include Expert or Peer Review Opinion 303 (collectively the “opinions”). In an embodiment, a classification and interpretation algorithm may be applied to the opinions 303. In another embodiment, the classification and interpretation algorithm may be comprised of at least one of a machine learning algorithm, a pattern recognition algorithm, a template matching algorithm, a statistical inference algorithm, and an artificial intelligence algorithm. In a further embodiment, the classification and interpretation algorithm may operate based on a learning model. In yet a further embodiment, the learning model may be comprised of at least one of a kNN, a Naïve Bayes, a SVM, an ANN, and a Decision Tree. As a nonlimiting example, if the opinions 303 are only available in a written format, a similar NLP may be applied for scanning and data extraction. An administrator may manually enter this information into the system 300. In an embodiment, the classification and interpretation algorithm may extract the opinions for data, thus producing an extracted opinion feature.

Further, the claim may include Social Determinants of Health 304. In an embodiment, the Social Determinants of Health 304 may be aggregated and/or analyzed. In another embodiment, the analyzation may be achieved via a kNN, a Naïve Bayes, a SVM, an ANN, and/or a Decision Tree from public and/or private databases. The Social Determinants of Health 304 may include patient income, patient race, patient employment status, a number of people dependent upon the patient, and/or any outstanding claims related to the patient, payer, or provider. In an alternative embodiment, the analyzation of the Social Determinants of Health 304 may produce at least one analyzed social determinant of health.

In one embodiment, some or all aforementioned embodiments of the claim or prior authorization approval process including, but not limited to, Documentation 301, Imaging 302, Expert or Peer Review Opinion 303, and Social Determinants of Health 304, may be processed simultaneously or in sequence using artificial intelligence-based decision supportive processes and parameters to arrive at a verdict. In another embodiment, at least one of the extracted document feature, the extracted image feature, the extracted opinion feature, and the at least one analyzed social determinant of health may be compiled to create compiled patient data. In another embodiment, the compiled patient may be evaluated, wherein said evaluation produces a recommendation. The recommendation may be at least one of a health insurance claim approval and a health insurance claim denial. Further, the system 300 may provide a recommendation for a course of clinical action where appropriate based upon the compiled patient data. In yet a further embodiment, the system 300 may provide a recommendation on the likelihood of success of the musculoskeletal intervention. Moreover, the system 300 may iteratively update the recommendation as more patient information is inputted into the system 300. Said parameters may carry an unspecified weight. Further, the parameters may be combined with a preexisting verdict surrounding past prior authorization decisions. Similarly, the parameters surrounding the claim and/or prior authorization approvals are amenable to new evidence, medical expertise opinion, or modification with new data. The method by which these processes are simultaneously weighed can be performed using any myriad of artificial intelligence-based processes, networks, or algorithms such as a kNN, a Naïve Bayes, a SVM, an ANN, and/or a Decision Tree. The output of such an embodiment may provide a prediction, recommendation, or likelihood in the form of a binary response or quantitative likelihood of receiving or recommending claim or prior authorization approval from a specific health insurance payer. In the event a negative recommendation (i.e., claim rejection, claim denial, prior authorization request denial, or low likelihood of receiving approval) occurs, one embodiment may provide a recommendation to fulfill missing elements that may result in a positive recommendation (i.e., prior authorization request approval or high likelihood of receiving approval), such as additional documentation, further imaging, continued observation, alternative treatment modalities, or other recommendations.

Reference herein to “one embodiment” or to “an embodiment” means that a particular feature, structure, or characteristic described in connection with the embodiment is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, visual, auditory or optical signals capable of being stored, transferred, combined, compared and otherwise manipulated. It is convenient at times, principally for reasons of common usage, to refer to these signals as bits, values, pixels, elements, symbols, characters, terms, numbers, or the like. Furthermore, it is also convenient at times, to refer to certain arrangement of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), hat manipulates and transforms data represented as physical (electronic) quantities within the computing system memories or registers or other such information storage, transmission or display devices.

Certain aspects of the embodiments include process steps and instructions herein in the form of an algorithm. It should be noted that the process steps and instructions of the embodiments can be embodied in software, firmware or hardware, and when embodied in software, firmware or hardware, and when embodied in software could be downloaded to reside on and be operated from different platforms used by a variety of operating systems. The embodiments can also be in a computer program product, which can be executed on a computing system.

The embodiments also relate to an apparatus for performing the operations herein. This apparatus may be specially constructed for the purposes (e.g., a specific computer), or it may comprise a general purpose computer selectively activated or reconfigured by a computer program stored in the computer. Such a computer program may be stored in a computer readable storage medium, such as but is not limited to, any type of disk including floppy disks, optical disks, CD-ROMs, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specifications may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

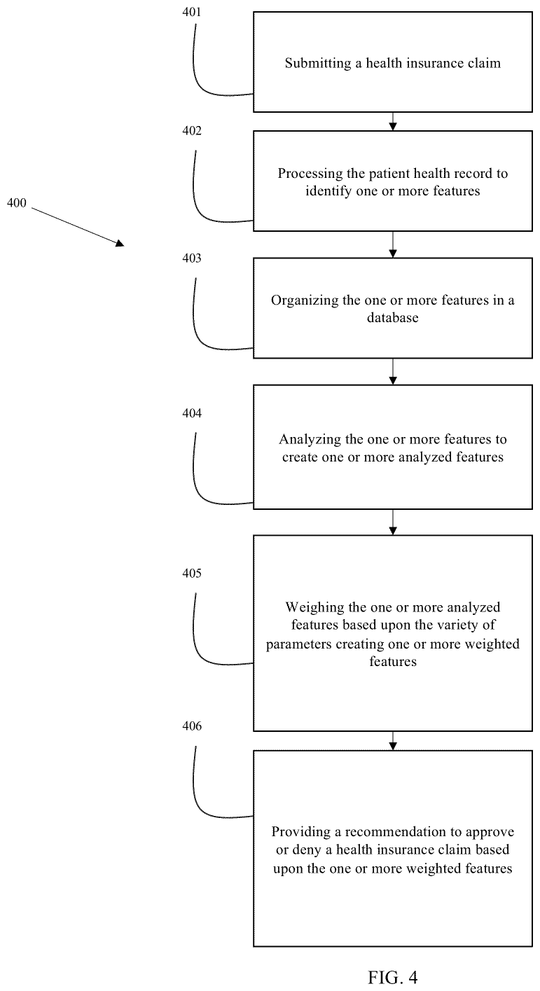

Referring to FIG. 4, a method 400 may be employed to streamline health insurance claims adjudication in musculoskeletal diagnostics and interventions. Further, the method 400 may generate a health insurance claim approval or a health insurance claim denial based upon a patient health record. In a first step of said method 401, a health insurance claim may be submitted. In an embodiment, the claim may contain the patient health record. In a second step 402 of the method, the patient health record may be processed, via the processor 202, wherein said processing may be performed by at least one algorithm. In an embodiment, the at least one algorithm may be at least one of a Convolutional Neural Network, an ANN, a kNN, a Naïve Bayes, a SVM, and a Decision Tree. In an alternative embodiment, the processing step 402 may identify one or more features from the health record. In another embodiment, the health record may be comprised of at least one of patient documentation (e.g., healthcare provider notes, at least one doctor's report, etc.), patient imaging (e.g., radiographic imaging, histologic pathology, serology data, etc.), expert and/or peer reviews, and social determinants of health (e.g., patient income, patient education, patient race, patient employment status, a number of people dependent upon the patient, any outstanding claims related to the patient, etc.). In a third step of the method 403, the one or more features may be organized in the memory 230, via the processor 202, such that the one or more features may be easily parsed and/or identified. In a fourth step of the method 404, the one or more features may be analyzed, via the processor 202, based on a variety of parameters, creating one or more analyzed features. In an embodiment, the variety of parameters may include expert adjudications, updated clinical practice guidelines, and/or new evidence. Further, the analyzation may be performed via the at least one algorithm. The method may employ a fifth step 405, wherein the one or more analyzed features from the patient health record may be given a weight based upon the variety of parameters, creating one or more weighted features. In an embodiment, the variety of parameters may be combined with a preexisting verdict surrounding past prior authorization decisions. In a further embodiment, the variety of parameters may be amenable to new evidence, medical expertise opinion, or modification with new data. In a sixth step of the method 406, a recommendation may be provided, via the processor 202, based upon the one or more weighted features, wherein said recommendation may be one of two options (i.e., health insurance claim approval or health insurance claim denial).

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A system streamlining health insurance claims adjudication, the system comprising a server comprising at least one server processor, at least one server database, at least one server memory comprising a set of computer-executable server instructions which, when executed by the at least one server processor, cause the server to:
initiate the system upon receipt of a claim,
the claim comprising at least one of:
at least one document,
at least one image,
at least one peer review, and
at least one social determinant of health;
process the at least one document to produce at least one document feature;
extract the at least one document feature to produce an extracted document feature;
process the at least one image to produce at least one image feature;
extract the at least one image feature to produce an extracted image feature;
extract, via a classification and interpretation algorithm, the at least one peer review to produce an extracted opinion feature;
analyze at least one social determinant of health to produce at least one analyzed social determinant of health;
compile the extracted document feature, the extracted image feature, the extracted opinion feature, and the at least one analyzed social determinant of health to produce a compiled patient data;
evaluate the compiled patient data; and
produce, based upon the evaluation of the compiled patient data, at least one of a claim approval and a claim denial.

2. The system of claim 1, wherein the at least one document is comprised of at least one of healthcare provider notes from an encounter with the patient and at least one doctor's report.

3. The system of claim 1, wherein the at least one image is comprised of at least one of radiographic imaging, histologic pathology, and serology data.

4. The system of claim 1, wherein processing the at least one document is performed by at least one algorithm.

5. The system of claim 4, wherein the at least one algorithm is selected from the group consisting of a Convolutional Neural Network, an ANN, a kNN, a Naïve Bayes, a SVM, and a Decision Tree.

6. The system of claim 5, wherein processing the at least one image is performed by the at least one algorithm.

7. The system of claim 5, wherein analyzing the at least one social determinant of health is performed by the at least one algorithm.

8. The system of claim 1, wherein the set of computer-executable server instructions which, when executed by the at least one server processor, cause the server to:
provide a recommendation for a course of clinical action based upon the compiled patient data.

9. The system of claim 1, wherein the set of computer-executable server instructions which, when executed by the at least one server processor, cause the server to:
provide a recommendation on a likelihood of success of a musculoskeletal intervention.

10. A computer-implemented method for tracking sentiment and topic modeling of one or more insights, comprising the steps of:
receiving a claim containing a patient health record;
processing the patient health record to create one or more features;
organizing the one or more features;
analyzing the one or more features, based upon a variety of parameters creating one or more analyzed features;
assigning a weight to the one or more analyzed features based upon the variety of parameters; and
providing a recommendation based upon the one or more analyzed features.

11. The method of claim 10, wherein the patient health record is comprised of at least one of patient documentation, patient imaging, expert and peer reviews, and social determinants of health.

12. The method of claim 10, wherein the processing of the patient health record is performed by at least one algorithm.

13. The method of claim 12, wherein the at least one algorithm is selected from the group consisting of a Convolutional Neural Network, an ANN, a kNN, a Naïve Bayes, a SVM, and a Decision Tree.

14. The method of claim 10, wherein the analyzing the one or more features is performed by at least one algorithm.

15. The method of claim 10, wherein the recommendation is at least one of a health insurance claim approval and a health insurance claim denial.
